(19) United States
(12) Patent Application Publication
(10) Pub. No.: US 2020/0365028 A1
(43) Pub. Date: Nov. 19, 2020

(54) SEMITRAILER COLLISION AVOIDANCE SYSTEM

(71) Applicant: George Kenneth Hayes, Calhoun, GA (US)

(72) Inventor: George Kenneth Hayes, Calhoun, GA (US)

(21) Appl. No.: 15/931,578

(22) Filed: May 13, 2020

Related U.S. Application Data
(60) Provisional application No. 62/847,315, filed on May 13, 2019.

(51) Int. Cl. G08G 1/16; H04W 4/80; H04W 4/40; H04N 5/225; H04N 7/18; H04N 7/04; B60R 1/00; B60Q 9/00; B60Q 1/00

(52) U.S. Cl. CPC G08G 1/16; H04W 4/80; H04W 4/40; H04N 5/2253; H04N 5/2252; H04N 7/183; B60R 2300/802; B60R 1/002; B60Q 9/008; B60Q 1/0023; B60R 2300/10; B60R 2300/20; H04N 7/04

(57) ABSTRACT

Implementations of a semitrailer collision avoidance system are provided. In some implementations, the semitrailer collision avoidance system comprises a camera system and an application, such as a mobile application or a software application, for interfacing with the camera system using a computing device, such as a portable smart phone/device or a semi/non-portable video monitor device.

In some implementations, an example method of using the semitrailer collision avoidance system comprises attaching the camera system to a semitrailer, pairing the camera system and the computing device using the application, and monitoring one or more areas adjacent to the semitrailer with the camera system using the application on the computing device to avoid a collision or other accident of the semitrailer.

### CROSS REFERENCE TO RELATED APPLICATION

This application claims the benefit of U.S. Patent Application Ser. No. 62/847,315, which was filed on May 13, 2019, and is incorporated herein by reference in its entirety.

### TECHNICAL FIELD

This disclosure relates to implementations of a semitrailer collision avoidance system.

### BACKGROUND

FIGS. 3A and 3B illustrate a semitrailer (or trailer) and a truck tractor (or tractor), which connected together form a tractor trailer or semi-truck. As shown in FIG. 3C, the trailer is a motorless wheeled vehicle that, as shown in FIGS. 3A and 3B, is towed by the tractor which is driven by a truck driver (or driver). Trailers that are picked up from a location and dropped off at another location using a tractor are referred to as drop trailers, such as illustrated by FIGS. 3B and 3C. The drop-off of such drop trailers usually involves backing up the trailer with the tractor, such as toward a loading dock as shown in FIGS. 3B and 3C.

Trailer collision accidents from tractor trailers backing up account for over 60% of all tractor trailer accidents. Therefore, backing up is a high risk operation for tractor trailer drivers. As a result, an important safety procedure developed for tractor trailer drivers is “G.O.A.L.”, which stands for Get Out And Look. The G.O.A.L. safety procedure includes drivers getting out and looking for obstacles or other back-up hazards before backing up a tractor trailer. However, drop trailers do not include cameras installed on the trailers to assist tractor trailer drivers when backing up the trailers, such as to assist with performing the G.O.A.L. safety procedure. Furthermore, drop trailers do not include such cameras that drivers can interface with using a mobile application or a software application accordingly on a portable, semi-portable, or non-portable computing device.

### BRIEF DESCRIPTION OF THE DRAWINGS

FIG. 1 illustrates an implementation of an example environment of a semitrailer collision avoidance system according to the present disclosure.

FIG. 2 illustrates an example computer system, which may be used with implementations of the present disclosure.

FIGS. 3A-3E illustrate various views of a semitrailer and a truck tractor, which connected together form a tractor trailer, and for which the semitrailer collision avoidance system can be used.

FIG. 4A illustrates a block diagram representation of an example camera system of a semitrailer collision avoidance system according to the present disclosure.

FIG. 4B illustrates an example perspective view of the camera system of the semitrailer collision avoidance system according to the present disclosure.

FIG. 4C illustrates another example perspective view of the camera system of the semitrailer collision avoidance system according to the present disclosure.

### DETAILED DESCRIPTION

Implementations of a semitrailer collision avoidance system are provided. In some implementations, the semitrailer collision avoidance system comprises a camera system and an application, such as a mobile application or a software application, for interfacing with the camera system using a computing device such as a smart phone/device or a video monitor(ing) device.

In some implementations, the computing device may be portable, such as the smart phone/device (e.g., an iPhone® or iPad®), and be used with the mobile application. In some implementations, the computing device may be portable, semi-portable, or non-portable, such as the video monitor(ing) device (e.g., a laptop, all-in-one computer, or other suitable monitor device), and be used with the software application.

Therefore, the mobile application and the software application may be referred to collectively herein as an “application” or “software”. Similarly, the portable, semi-portable, or non-portable computing device may be referred to collectively herein as a “computing device”.

In some implementations, the camera system comprises a housing, an attachment mechanism, a camera, a power source, and a computer system. In some implementations, the camera system may further comprise a light source, a sensor, and/or a removable media memory device.

In some implementations, the camera system is configured to be portable.

In some implementations, the camera system is configured to removably attach to a semitrailer (“trailer”) of a tractor trailer. For example, in some implementations, the camera system is configured to be attached to the trailer by a tractor trailer driver.

In some implementations, the camera system is configured to attach to any suitable position on the trailer. For example, in some implementations, the camera system is configured to attach to any suitable position on the side (i.e., left or right) of the trailer. In some implementations, the camera system is configured to attach to any suitable position on the back of the trailer.

In some implementations, the camera system is configured to attach to any suitable position on the tandem axle assembly (or “tandem”) of the trailer. In some implementations, the camera system is configured to attach to any other suitable position on the trailer.

In some implementations, the camera system is configured to attach to any suitable position on the trailer to monitor one or more areas adjacent to the trailer. For example, in some implementations, the camera system is configured to attach to the trailer to monitor behind the trailer. In some implementations, the camera system is configured to attach to the trailer to monitor beside the trailer.

In some implementations, the camera system is configured to attach to the trailer to monitor under the trailer. In some implementations, the camera system is configured to attach to the trailer to monitor any other suitable area(s) adjacent to the trailer.

In some implementations, the camera system is configured to monitor one or more areas adjacent to the trailer to avoid a collision or other accident of the trailer. For example, in some implementations, the camera system is configured to monitor area(s) adjacent to the trailer to avoid an obstacle or other hazard when backing up the trailer.

In some implementations, the camera system is configured to monitor area(s) adjacent to the trailer to avoid an obstacle or other hazard when adjusting the position of (or “sliding”) the tandem of the trailer. In some implementations, the camera system is configured to monitor area(s) adjacent to the trailer to avoid any other applicable collisions or accidents during any other suitable operation of the trailer.

In some implementations, the camera system is configured to provide a camera function. For example, in some implementations, the camera system is configured to provide video and/or pictures of area(s) monitored by the camera system. In some implementations, the camera system is configured to provide live stream video of area(s) monitored by the camera system. In some implementations, the camera system is configured to provide any other suitable camera function.

In some implementations, the camera system is configured to provide an infrared camera function. In some implementations, the camera system is configured to provide any other suitable type of camera function.

In some implementations, the camera system is configured to provide a light source. For example, in some implementations, the camera system is configured to provide a light source to allow the camera function(s) during darkness or other low light conditions. In some implementations, the camera system is configured to provide a light source for any other suitable purpose.

In some implementations, the camera system is configured to provide a sensor function. For example, in some implementations, the camera system is configured to provide a sensor function that detects objects or other obstacles.

In some implementations, the camera system is configured to provide a proximity sensor function. In some implementations, the camera system is configured to provide a laser operated proximity sensor function that includes real-time distance measurement. In some implementations, the camera system is configured to provide any other suitable type of sensor function.

In some implementations, the camera system is configured to automatically turn on and/or off one or more components of the camera system. For example, in some implementations, the camera system is configured to automatically turn on and/or off the camera of the camera system. In some implementations, the camera system is configured to automatically turn on and/or off the light source of the camera system. In some implementations, the camera system is configured to automatically turn on and/or off any other suitable component of the camera system.

In some implementations, the camera system is configured to turn on and/or off one or more components of the camera system through the application using a computing device such as a smart phone/device or video monitor device.

In some implementations, the camera system is configured to accessibly enclose one or more components of the camera system. In some implementations, the camera system is configured to waterproof enclose one or more components of the camera system. In some implementations, the camera system is configured to enclose one or more components of the camera system in any other suitable way.

In some implementations, the camera system is configured to be portably powered. In some implementations, the camera system is configured to be rechargeably powered.

In some implementations, the camera system is configured to be interfaced through the application using a computing device such as a smart phone/device or a video monitor device to which the application is downloaded and/or installed. For example, in some implementations, the camera system is configured to allow video and/or pictures (or “images”) that are captured and transmitted from the camera system to be received and viewed through the application using a computing device. In some implementations, the camera system is configured to wirelessly transmit video and/or pictures that are captured by the camera system.

In some implementations, the camera system is configured to allow one or more functions of the camera system to be started and/or stopped through the application using a computing device. In some implementations, the camera system is configured to allow one or more functions of the camera system to be programmed through the application using a computing device. In some implementations, the camera system is configured to be otherwise monitored and/or controlled through the application using a computing device.

In some implementations, the camera system is configured to be paired (e.g., wirelessly connected) to a computing device such as a smart phone/device or a video monitor device. In some implementations, the camera system is configured to be paired to a unique or specific computing device. In some implementations, the camera system is configured to be paired or otherwise connected to a computing device in any other suitable way.

In some implementations, the camera system is configured to save and/or store video and/or pictures to a removable media memory such as an SD (Secure Digital) memory card. For example, in some implementations, the camera system is configured to save and/or store video and/or pictures to a removable media memory for insurance, police, and/or safety review purposes (e.g., in case of an accident).

In some implementations, the camera system is configured to save and/or store video and/or pictures to any other suitable removable media memory.

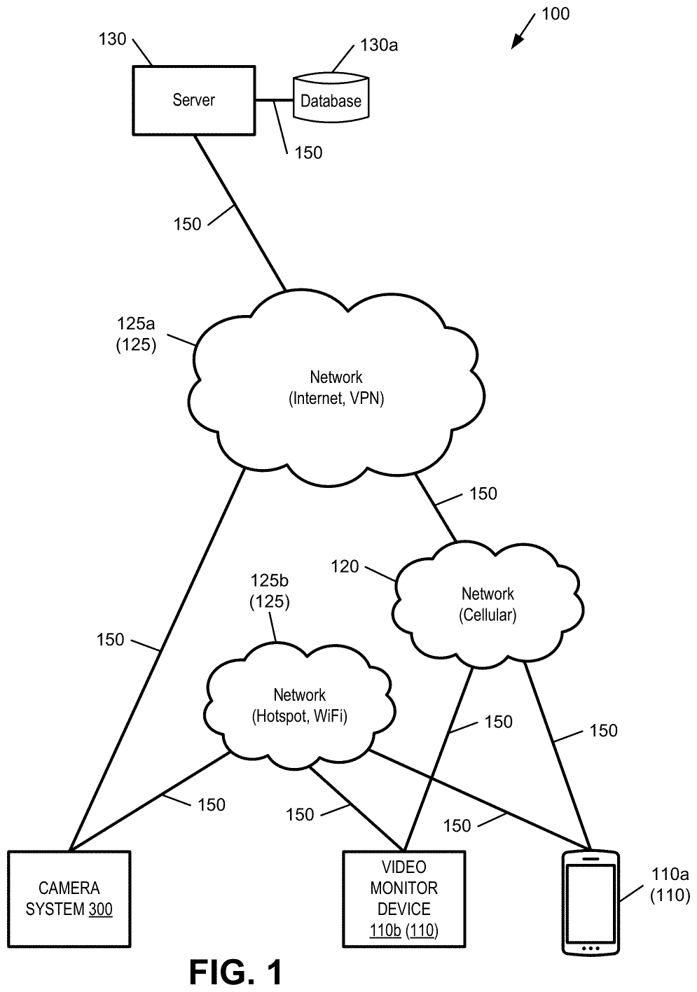

In some implementations, the camera system may be configured to save and/or store video and/or pictures to a cloud based storage memory. For example, in some implementations, the camera system may be configured to save and/or store video and/or pictures to a data storage of a remote server, such as described below for FIG. 1.

In some implementations, the camera system may be configured to save and/or store video and/or pictures to any other suitable type of memory.

In some implementations, the camera system is configured to be used with the G.O.A.L. (i.e., Get Out And Look) safety procedure to aid a tractor trailer driver in backing up. For example, in some implementations, the camera system is configured to be attached to or otherwise positioned on a trailer after the driver gets out and looks before backing up a trailer. In some implementations, the camera system is configured to be positioned on the trailer so that the camera system can monitor an area adjacent to the trailer to aid in backing up.

In some implementations, the application is configured to be downloaded and/or installed to a computing device such as a smart phone/device or a video monitor device. In some implementations, the application is configured to interface with the camera system using the computing device. For example, in some implementations, the application is configured to receive and display video and/or pictures using a computing device of area(s) monitored by the camera system.

In some implementations, the application is configured to receive and display video and/or pictures using a computing device that are captured and transmitted from the camera system. In some implementations, the application is configured to receive video and/or pictures using a computing device that are wirelessly transmitted from the camera system.

In some implementations, the application is configured to display live stream video using a computing device of area(s) monitored by the camera system.

In some implementations, the application is configured to rotate or otherwise modify the display orientation of the video and/or pictures that are transmitted from the camera system to the computing device. For example, in some implementations, the application is configured to rotate or otherwise modify the display orientation of the video and/or pictures depending on the position and/or orientation of the camera system attached to the trailer. In some implementations, the application is configured to rotate or otherwise modify the display orientation of the video and/or pictures to provide a desired viewing orientation for the user such as the tractor trailer driver.

In some implementations, the application is configured to turn on and/or off one or more components of the camera system using a computing device such as a smart phone/device or a video monitor device. In some implementations, the application is configured to start and/or stop one or more functions of the camera system using a computing device.

In some implementations, the application is configured to program one or more functions of the camera system using a computing device. In some implementations, the application is configured to otherwise monitor and/or control the camera system using a computing device.

In some implementations, the application is configured to pair (e.g., wirelessly connect) a computing device such as a smart phone/device or a video monitor device to the camera system. In some implementations, the application is configured to pair a unique or specific computing device to the camera system. In some implementations, the application is configured to pair or otherwise connect a computing device to the camera system in any other suitable way.

In some implementations, the application is configured to provide a warning or alert from the computing device to the user, such a tractor trailer driver. For example, in some implementations, the application is configured to provide an alert in response to the camera system transmitting an indication of a detection of an obstacle in area(s) monitored by the camera system.

In some implementations, the application is configured to provide an alert in response to the camera system detecting an obstacle within a certain proximity of the trailer to which the camera system is attached. In some implementations, the application is configured to provide an alert in response to the camera system detecting any other applicable monitored condition with respect to the trailer.

In some implementations, the application is configured to provide an audible alert from the computing device. In some implementations, the application is configured to provide a visible alert from the computing device. In some implementations, the application is configured to provide any other suitable alert from the computing device.

In some implementations, the application is configured to wirelessly receive video and/or pictures from the camera system to a tractor trailer driver's smart phone/device or a video monitor device to display the video and/or pictures on the device. For example, in some implementations, the application is configured to be used in such manner for the G.O.A.L. (i.e., Get Out And Look) safety procedure to aid a tractor trailer driver in backing up.

In some implementations, the application is configured to receive and display video and/or pictures from the camera system after the driver attaches the camera system to the trailer during the G.O.A.L. safety procedure before backing up a trailer. In some implementations, the application is configured to display video and/or pictures from the appropriately positioned camera system so that the driver can monitor an area adjacent to the trailer to aid in backing up while avoiding a collision or other accident.

In some implementations, the application is configured to display video and/or pictures from the appropriately positioned camera system so that the driver can monitor an area adjacent to the trailer to aid in sliding the tandem of the trailer while avoiding a collision or other accident and/or appropriately repositioning the tandem along the bottom of the trailer.

In some implementations, an example method of using the semitrailer collision avoidance system comprises attaching the camera system to a trailer, pairing the camera system and the computing device using the application, and monitoring one or more areas adjacent to the trailer with the camera system using the application on the computing device to avoid a collision or other accident of the trailer.

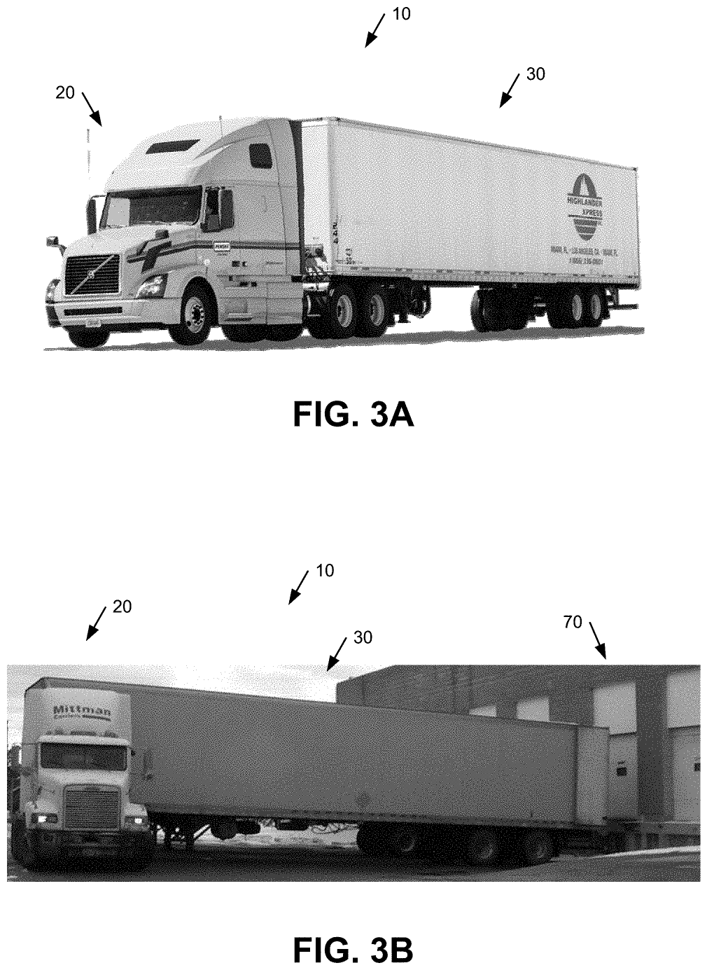

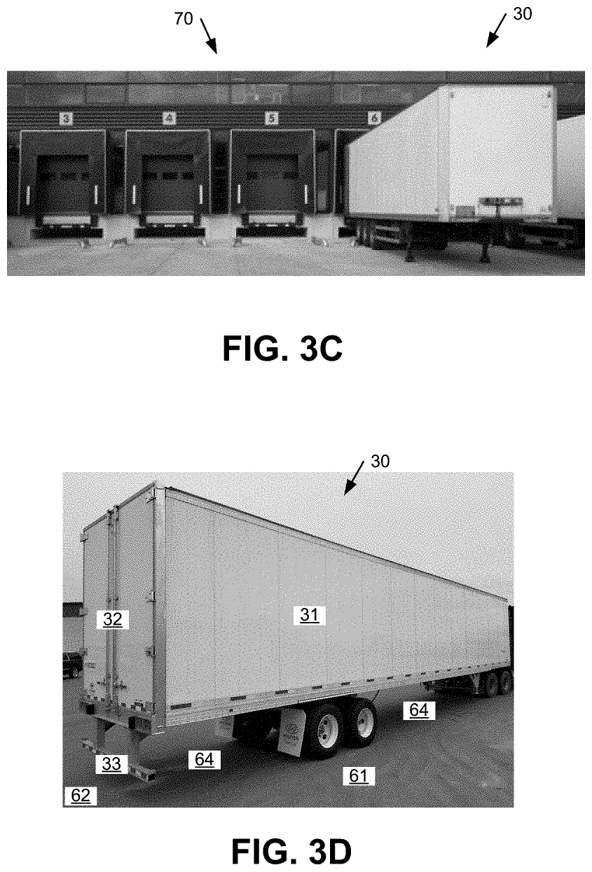

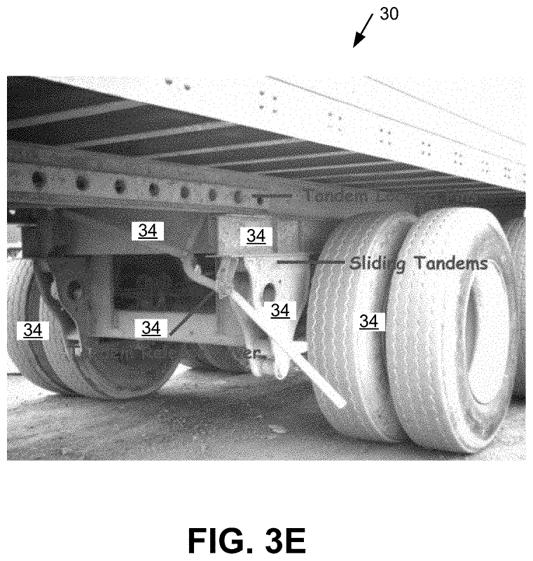

FIGS. 3A and 3B illustrate a semitrailer (or “trailer”) 30 and a truck tractor (or “tractor”) 20, which connected together form a tractor trailer 10 (or semi-truck). As shown in FIG. 3C, the trailer 30 is a motorless wheeled vehicle that, as shown in FIGS. 3A and 3B, is towed by the tractor 20 which is driven by a truck driver (or “driver”). Trailers 30 that are picked up from a location and dropped off at another location using a tractor 20 are referred to as drop trailers 30, such as illustrated by FIGS. 3B and 3C. The drop-off of such drop trailers 30 usually involves backing up the trailer 30 with the tractor 20, such as toward a loading dock 70 as shown in FIGS. 3B and 3C.

Trailer 30 collision accidents from tractor trailers 10 backing up account for over 60% of all tractor trailer 10 accidents. Therefore, backing up is a high risk operation for tractor trailer 10 drivers. As a result, an important safety procedure developed for tractor trailer 10 drivers is “G.O.A.L.”, which stands for Get Out And Look. The G.O.A.L. safety procedure includes drivers getting out and looking for obstacles or other back-up hazards before backing up a tractor trailer 10. However, drop trailers 30 do not include cameras installed on the trailers 30 to assist tractor trailer 10 drivers when backing up the trailers 30, such as to assist with performing the G.O.A.L. safety procedure. Furthermore, drop trailers 30 do not include such cameras that drivers can interface with using a mobile application or a software application accordingly on a portable, semi-portable, or non-portable computing device.

As described further below with respect to FIG. 1, in some implementations, the semitrailer collision avoidance system 100 comprises a camera system 300 and an application, such as a mobile application or a software application, for interfacing with the camera system 300 using a computing device 110, such as a smart phone/device or a video monitor(ing) device.

In some implementations, the computing device 110 may be portable, such as the smart phone/device (e.g., an iPhone® or iPad®), and be used with the mobile application. In some implementations, the computing device 110 may be portable, semi-portable, or non-portable, such as the video monitor(ing) device (e.g., a laptop, all-in-one computer, or other suitable monitor device), and be used with the software application.

Therefore, as noted above, the mobile application and the software application may be referred to collectively herein as an “application” or “software”. Similarly, the portable, semi-portable, or non-portable computing device may be referred to collectively herein as a “computing device”.

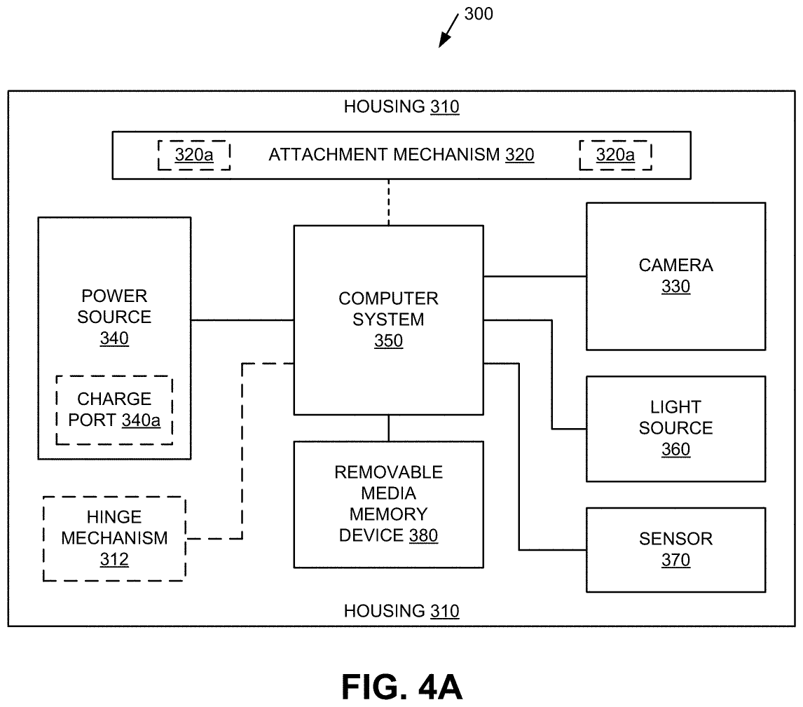

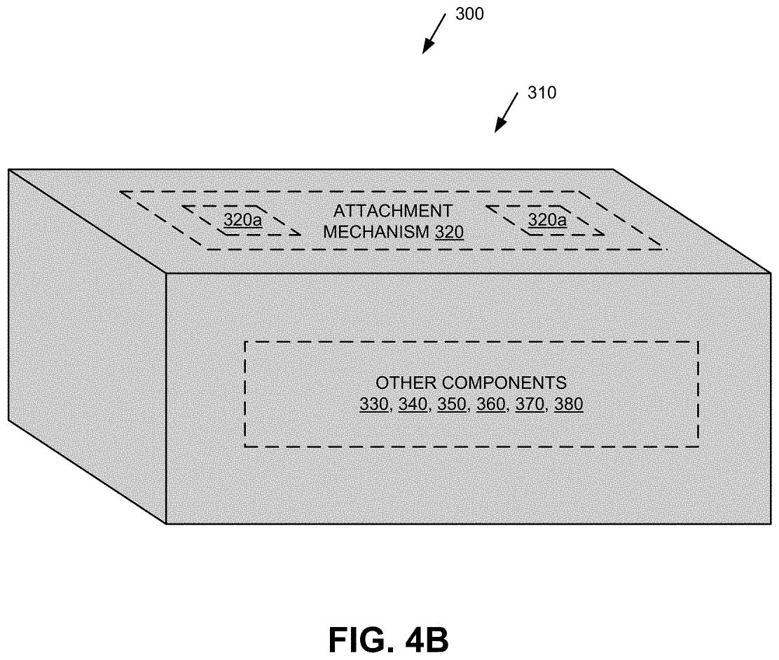

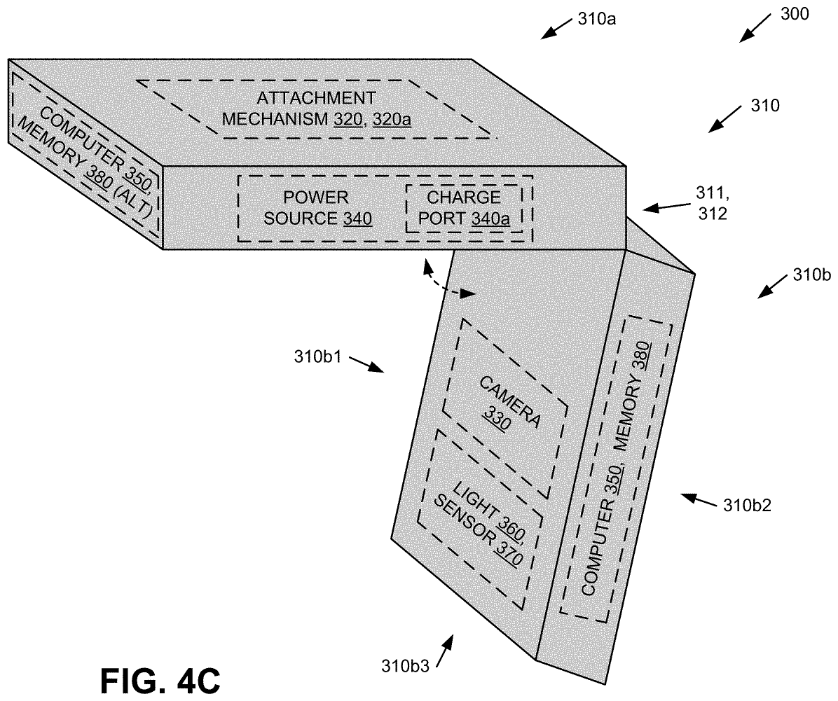

FIGS. 4A-4C illustrate an example camera system 300 of the semitrailer collision avoidance system 100 according to the present disclosure. FIG. 4A illustrates a block diagram representation of the camera system 300. FIGS. 4B and 4C illustrate example perspective views of the camera system 300.

As shown in FIG. 4A-4C, in some implementations, the camera system 300 comprises a housing 310, an attachment mechanism 320, a camera 330, a power source 340, and a computer system 350. In some implementations, the camera system may further comprise a light source 360, a sensor 370, and/or a removable media memory device 380.

In some implementations, the camera system 300 may further comprise other suitable components.

As shown in FIG. 4B, in some implementations, the housing 310 may have an at least generally square or rectangular box shape. For example, in some implementations, the housing 310 may be at least generally rectangular prism shaped such that the housing 310 comprises a plurality of opposite facing/positioned sides/surfaces defining an interior and exterior of the housing 310.

In that regard, in some implementations, the housing 310 may comprise a first (e.g., top) side and an opposite, second (e.g., bottom) side, a third (e.g., front) side and an opposite, fourth (e.g., back) side, and a fifth (e.g., left) side and an opposite, sixth (e.g., right) side. In some implementations, the housing 310 may have any other suitable shape and/or configuration.

As shown in FIG. 4C, in some implementations, the housing 310, such as described herein for FIGS. 4A and 4B, may comprise a first part 310a and a second part 310b.

In some implementations, the first part 310a and the second part 310b are shaped and sized such that the parts 310a, 310b form the housing 310, such as described for FIG. 4B, when joined/positioned together. In some implementations, the parts 310a, 310b are also shaped and sized such that the parts 310a, 310b provide the features and functions of the housing 310 described herein, whether the parts 310a, 310b are joined together or at least partly separated apart (e.g., as shown in FIG. 4C).

For example, in some implementations, the parts 310a, 310b may be at least generally rectangular prism shaped the same or similar to as described herein for the housing 310 in FIG. 4B. In some implementations, the parts 310a, 310b may have any other suitable shape and/or configuration.

As shown in FIG. 4C, in some implementations, the parts 310a, 310b are movably connected together at one end by a hinge 311 or other suitable movable connecting component.

In some implementations, the parts 310a, 310b are movably connected together by such component 311 such that the second part 310b can rotate/move apart from the first part 310a to at least partly separate apart the parts 310a, 310b. In some implementations, the parts 310a, 310b may be movably connected together such that the parts 310a, 310b can rotate/move apart in any other suitable way.

Similarly, in some implementations, the parts 310a, 310b are movably connected together by such component 311 such that the parts 310a, 310b can also rotate/move back together.

As shown in FIG. 4C, in some implementations, the hinge 311 may be operable by a hinge mechanism 312 and/or any other suitable device. In some implementations, the hinge 311 may be operable by such mechanism/device 312 to remotely and/or automatically rotate/move the parts 310a, 310b apart/together during use/operation of the camera system 300.

In some implementations, the hinge mechanism 312 may be connected and/or integrated to the hinge 311 and/or the housing 310. In some implementations, the hinge mechanism 312 may be connected and/or integrated to any other suitable component of the camera system 300, such as shown in FIG. 3A.

As shown in FIGS. 4A-4C, in some implementations, the housing 310 is configured to contain or otherwise enclose components of the camera system 300. As shown in FIG. 4C, in some implementations, the housing parts 310a, 310b may each be configured to contain or otherwise enclose components of the camera system 300.

For example, as shown in FIG. 4C, in some implementations, the first part 310a may at least house the attachment mechanism 320 and the power source 340. Similarly, in some implementations, the second part 310b may at least house the camera 330, the computer system 350, the light source 360, the sensor 370, and the memory device 380.

In some implementations, the camera 330, the light source 360, and/or the sensor 370 may be housed by the second part 310b such that one or more of the components 330, 360, 370 operate through the top side 310b 1, the bottom side 310b 2, and/or the left (or right) side 310b 3 of the second part 310b. For example, in some implementations, the camera 330 may be housed such that the camera 330 captures video and/or pictures through the top side 310b 1, the bottom side 310b 2, and/or the left (or right) side 310b 3 of the second part 310b when the camera system 300 is used/operated.

Similarly, in some implementations, the light source 360 and/or the sensor 370 may be housed such that the components 360, 370 operate through the top side 310b 1, the bottom side 310b 2, and/or the left (or right) side 310b 3 of the second part 310b when the camera system 300 is used/operated.

As shown in FIG. 4C, in some implementations, the computer system 350 and the memory device 380 may alternately be housed by the first part 310a. In some implementations, the first part 310a and the second part 310b may house any other suitable combination of the components of the camera system 300.

In some implementations, the housing 310 is configured to provide a waterproof enclosure of components of the camera system 300.

In some implementations, the housing 310 is configured to accessibly enclose components of the camera system 300. For example, in some implementations, the housing 310 may comprise one or more access openings into the housing 310. In some implementations, such access opening may be located on a back side of the housing 310. In some implementations, such access opening may be located at any other suitable location of the housing 310.

In some implementations, such access opening may allow access to one or more components of the camera system 300, such as the power source 340 and/or the removable media memory device 380. In some implementations, such access opening may provide any other suitable features with respect to the camera system 300.

In some implementations, the housing 310 is configured to provide a secure attachment position for components of the camera system 300, such as within and/or on one or more surfaces of the housing 310.

As shown in FIGS. 4A and 4B, in some implementations, the attachment mechanism 320 may comprise one or more magnets 320a. In some implementations, the magnets 320a may be rare earth magnets. In some implementations, the magnets 320a may be any other suitable magnets.

In some implementations, the attachment mechanism 320 may (alternately or additionally) comprise one or more suction cups 320a. In some implementations, the attachment mechanism 320 may comprise one or more of any other suitable attachment-capable components.

In some implementations, the magnets 320a are configured to attach the camera system 300 to steel or otherwise metallic and/or magnetically attracted portions of a trailer 30. In some implementations, the suction cups 320a are configured to attach the camera system 300 to aluminum, fiberglass, plastic, or otherwise nonmetallic and/or non-magnetically attracted portions of a trailer 30. In some implementations, the components of the attachment mechanism 320 may be configured to attach to any other suitable material that is part of a trailer 30.

In some implementations, the attachment mechanism 320 may be configured to position on one or more sides of the housing 310. For example, in some implementations, the attachment mechanism 320 may be configured to position on the top side of the housing 310. In some implementations, the attachment mechanism 320 may be configured to position on the bottom side of the housing 310. In some implementations, the attachment mechanism 320 may be configured to position on any other suitable location of the housing 310.

In some implementations, the attachment mechanism 320 may be configured to be removable from the housing 310. In some implementations, the attachment mechanism 320 may be configured to be repositionable on the housing 310.

In some implementations, the camera 330 may be any suitable camera that allows the use/operation of the camera system 300 and the semitrailer collision avoidance system 100 as described herein. For example, in some implementations, the camera 330 may be an infrared camera. In some implementations, the camera 330 may be a thermal camera.

In some implementations, the camera 330 may be any other suitable imaging type of camera. In some implementations, the camera 330 may be any other suitable type, style, and/or configuration of camera.

In some implementations, the camera 330 may comprise an automatic on and/or off switch (e.g., an auto on/off switch). In some implementations, the camera 330 may comprise any other suitable features.

In some implementations, the camera 330 is configured to provide video and/or pictures of area(s) monitored by the camera system 300. In some implementations, the camera 330 is configured to provide live stream video of area(s) monitored by the camera system 300. In some implementations, the camera 330 is configured to provide any other suitable functions.

In some implementations, the power source 340 may comprise a battery. In some implementations, the power source 340 may comprise a rechargeable battery. In some implementations, the power source 340 may comprise a battery with any other suitable features. In some implementations, the power source 340 may comprise any other suitable type of battery.

As shown in FIGS. 4A and 4C, in some implementations, the power source 340, such as a rechargeable battery, may be configured to be recharged through a USB port or other charging interface 340a of the power source 340. In some implementations, the power source 340 may be configured to be recharged by any other suitable way.

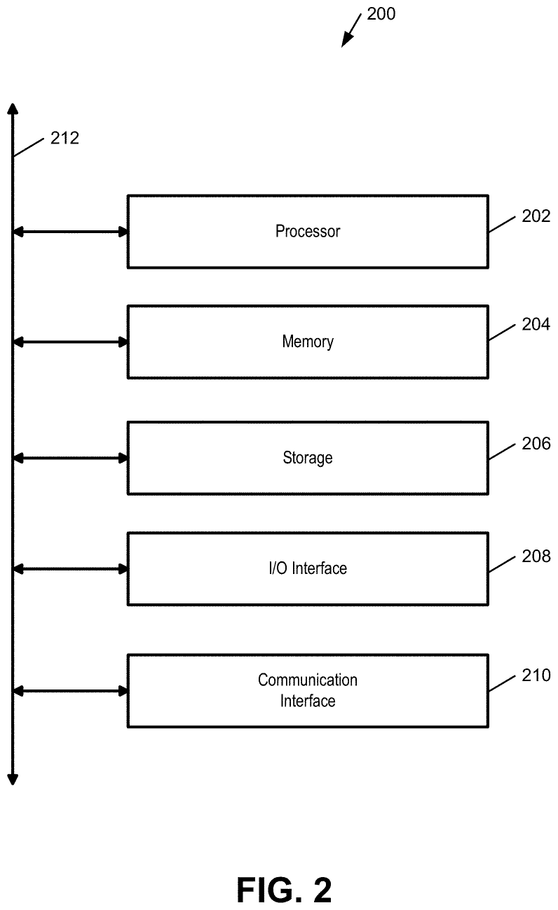

In some implementations, the computer system 350 may be the same or similar to the computer system 200 described below for FIG. 2. For example, in some implementations, the computer system 350 may be a system-on-chip (SOC) computer system or a single-board computer system (SBC). In some implementations, the computer system 350 may comprise a Raspberry PI (RPi) single-board computer system (e.g., that includes a Wi-Fi chip and/or other transmitter/receiver circuitry).

In some implementations, the computer system 350 may comprise one or more components on one or more circuit boards. In some implementations, the computer system 350 may comprise any other suitable components and/or configuration.

As shown in FIG. 4A, in some implementations, the computer system 350 may be connected or otherwise in communication with one or more of the components of the camera system 350. In some implementations, the computer system 350 may be so connected to control, monitor, or otherwise interact with the components.

In some implementations, the camera system 300 is configured to be interfaced through the computer system 350. In some implementations, the computer system 350 is configured to be interfaced by a computing device such as described below with respect to FIG. 1.

In some implementations, the computing device may be a smart phone/device (e.g., an iPhone® or iPad®) or a video monitor device (e.g., a laptop, all-in-one computer, or other suitable monitor device) to which the application is downloaded and/or installed.

In some implementations, the computing device may be portable, such as the smart phone/device, and be used with a mobile application. In some implementations, the computing device may be portable, semi-portable, or non-portable, such as the video monitor device, and be used with a software application.

Therefore, as noted above, the mobile application and the software application may be referred to collectively herein as an “application” or “software”. Similarly, the portable, semi-portable, or non-portable computing device may be referred to collectively herein as a “computing device”.

In some implementations, the computer system 350 is configured to allow video and/or pictures to be captured and transmitted from the camera system 300 to be received and viewed through the application using the computing device. In some implementations, the computer system 350 is configured to wirelessly transmit video and/or pictures that are captured by the camera system 300.

In some implementations, the computer system 350 is configured to allow one or more functions of the camera system 300 to be started and/or stopped through the application using the computing device. In some implementations, the computer system 350 is configured to allow one or more functions of the camera system 300 to be programmed through the application using the computing device. In some implementations, the computer system 350 is configured to be otherwise monitored and/or controlled through the application using the computing device.

In some implementations, the computer system 350 is configured to be paired (e.g., wirelessly connected) to the computing device. For example, in some implementations, the computer system 350 comprises Wi-Fi and/or other transmitter/receiver circuitry, such as described below for FIG. 2.

In some implementations, the computer system 350 is configured to be paired to a unique or specific computing device. In some implementations, the computer system 350 is configured to be paired or otherwise connected to the computing device in any other suitable way.

In some implementations, the light source 360 may comprise one or more light emitting diodes (LEDs). In some implementations, the light source 360 may comprise one or more other suitable light emitting components.

In some implementations, the light source 360 may be configured to provide light to allow the camera system 300 to function during darkness or other low light conditions. In some implementations, the light source 360 may be configured to provide light for any other suitable purpose.

In some implementations, the sensor 370 may be a proximity sensor. In some implementations, the sensor 370 may be a laser operated proximity sensor. In some implementations, the sensor 370 may be any other suitable type of sensor.

In some implementations, the sensor 370 may be configured to detect objects or other obstacles. In some implementations, the sensor 370 may be configured to measure real-time distance. In some implementations, the sensor 370 may be configured to provide any other suitable features.

In some implementations, the removable media memory device 380 may comprise an SD (Secure Digital) memory card device. In some implementations, the removable media memory device 380 may comprise any other suitable memory device.

In some implementations, the removable media memory device 380 may be configured to save and/or store video and/or pictures captured by the camera system 300. For example, in some implementations, the removable media memory device 380 may be configured to save and/or store video and/or pictures for insurance, police, and/or safety review purposes (e.g., in case of an accident).

In some implementations, the removable media memory device 380 may be configured to save and/or store video and/or pictures for any other suitable purpose.

In some implementations, the camera system 300 is configured to be portable.

In some implementations, the camera system 300 is configured to attach by the attachment mechanism 320 to any suitable position on a trailer 30, such as the positions shown in FIG. 3D. For example, in some implementations, the camera system 300 is configured to attach to any suitable position on the side 31 (i.e., left or right) of the trailer 30. In some implementations, the camera system 300 is configured to attach to any suitable position on the back 32 of the trailer 30.

In some implementations, the camera system 300 is configured to attach to any suitable position on the ICC (Interstate Commerce Commission) bumper 33 of the trailer 30, such as shown in FIG. 3D. As understood by one skilled in the art, the ICC bumper 33 is a bumper that prevents under-riding of vehicles that collide with the back 32 of the trailer 30.

In some implementations, the camera system 300 is configured to attach to any suitable position on the tandem axle assembly (or “tandem”) 34 of the trailer 30, such as shown in FIG. 3E. In some implementations, the camera system 300 is configured to attach to any other suitable position on the trailer 30.

In some implementations, the camera system 300 is configured to attach to any suitable position on the trailer 30 to monitor one or more areas adjacent to the trailer 30, such as shown in FIG. 3D. For example, in some implementations, the camera system 300 is configured to attach to the trailer 30 to monitor an area 62 behind the trailer 30. In some implementations, the camera system 300 is configured to attach to the trailer 30 to monitor an area 61 beside the trailer 30.

In some implementations, the camera system 300 is configured to attach to the trailer 30 to monitor an area 64 under the trailer 30. In some implementations, the camera system 300 is configured to attach to the trailer 30 to monitor any other suitable area(s) adjacent to the trailer 30.

One skilled in the art will understand, in accordance with the present disclosure, that one or more of the components shown in FIGS. 4A-4C may be block representations and therefore, features such as the shape, size, location, etc. of these components may vary, in accordance with the present disclosure, in any suitable way from what is shown in the FIGs.

In some implementations, the camera system 300 comprises any suitable dimensions. For example, in some implementations, the camera system 300 may be approximately two inches in length, width, and height (or depth), i.e. approximately 2″L×2″W×2″H. In some implementations, the camera system 300 may be less than approximately two inches in length, width, and/or height.

In some implementations, the camera system 300 may be more than approximately two inches in length, width, and/or height. In some implementations, the camera system 300 may have any other suitable dimensions.

In some implementations, the camera system 300 is composed of any suitable materials. For example, in some implementations, the housing 310 may be composed of an acrylic molded plastic. In some implementations, the housing 310 may be composed of an acrylic molded plastic that is approximately 0.375 inches (⅜″) thick.

In some implementations, the housing 310 may be composed of an acrylic molded plastic that is less than approximately 0.375 inches thick. In some implementations, the housing 310 may be composed of an acrylic molded plastic that is more than approximately 0.375 inches thick.

In some implementations, the camera system 300 can have any suitable appearance, such as the example appearance described above.

In some implementations, an example method of using the semitrailer collision avoidance system 100, with respect to the descriptions of the semitrailer collision avoidance system 100 herein according to the present disclosure, comprises attaching or otherwise positioning the camera system 300 on a trailer 30. In some implementations, the camera system 300 is attached to any suitable position on the trailer 30, such as described above with respect to FIGS. 3D and 3E. In some implementations, the camera system 300 is attached to the trailer 30 by the attachment mechanism 320, such as described above with respect to FIGS. 4A-4C.

With respect to the multi-part 310a, 310b housing 310 described for FIG. 4C, in some implementations, the first part 310a is attached/positioned adjacent to the trailer 30. In some implementations, the first part 310a is so attached/positioned on the trailer 30 such that the attachment mechanism 320 secures the camera system 300 to the trailer.

In some implementations, the first part 310a is so attached/positioned on the trailer 30 such that the second part 310b can be rotated/moved while the first part 310a is attached/positioned on the trailer 30. In some implementations, the second part 310b can be so rotated/moved such that the second part 310b can be at least partly separated from the first part 310a, such as described above for FIG. 4C, to use/operate the camera system 300.

In some implementations, the camera system 300 is attached to the trailer 30 by a tractor trailer 10 driver while performing the G.O.A.L. (i.e., Get Out And Look) safety procedure as described above. For example, in some implementations, the camera system 300 is attached to the trailer 30 by a tractor trailer 10 driver after the driver gets out and looks before backing up the trailer 30.

In some implementations, the method comprises pairing (e.g., wirelessly connecting) the camera system 300 and a computing device, such as the computing device 110 described below with respect to FIG. 1, which may be a smart phone/device (e.g., an iPhone® or iPad®) or a video monitor device (e.g., a laptop, all-in-one computer, or other suitable monitor device).

In some implementations, the camera system 300 and the computing device are paired through the application using the computing device. In some implementations, the application is downloaded and/or installed to the computing device, such as described herein.

In some implementations, the method comprises monitoring one or more areas adjacent to the trailer 30 to avoid a collision or other accident of the trailer 30, such as while backing up the trailer 30 or while sliding the tandem 34 of the trailer 30.

In some implementations, the area(s) adjacent to the trailer 30 are monitored to aid in backing up the trailer 30 while avoiding a collision or other accident.

In some implementations, the area(s) adjacent to the trailer 30 are monitored to aid in sliding the tandem 34 of the trailer while avoiding a collision or other accident and/or appropriately repositioning the tandem 34 along the bottom of the trailer 30.

In some implementations, monitoring the area(s) adjacent to the trailer 30 comprises using the application on the computing device to allow the camera system 300 to capture video and/or pictures of the area(s). In some implementations, the camera system 300 may automatically operate to capture the video and/or pictures of the area(s).

With respect to the multi-part 310a, 310b housing 310 described for FIG. 4C, in some implementations, monitoring the area(s) adjacent to the trailer 30 comprises at least partly separating the parts 310a, 310b. For example, as shown in FIG. 4C, in some implementations, the second part 310b is rotated/moved to at least partly separate the parts 310a, 310b while the first part 310a is attached/positioned on the trailer 30.

In some implementations, the second part 310b is rotated/moved remotely and/or automatically using the application on the computing device. In some implementations, the second part 310b may be rotated/moved automatically in response to the sensor 370 detecting objects or other obstacles with respect to the movement (such as backing up) of the trailer 30.

In some implementations, the second part 310b may be rotated/moved manually, such as by a tractor trailer 10 driver. In some implementations, the second part 310b may be rotated/moved in any other suitable way.

In some implementations, the second part 310b may be rotated/moved to position/orient the camera 330 and/or other camera system components, such as the light source 360 and/or the sensor 370, to use/operate the camera system 300. For example, in some implementations, the second part 310b may be rotated/moved to adjust the view that is captured by the camera 330 for the use/operation of the camera system 300.

In some implementations, the second part 310b may be rotated/moved to adjust the aim of the light source 360 and/or the sensor 370 for the use/operation of the camera system 300. In some implementations, the second part 310b may be rotated/moved for any other suitable use/operation of the camera system 300.

In some implementations, monitoring the area(s) adjacent to the trailer 30 comprises using the application on the computing device to allow the camera system 300 to transmit the captured video and/or pictures of the area(s) to the paired computing device.

In some implementations, monitoring the area(s) adjacent to the trailer 30 comprises using the application on the computing device to receive and view the captured video and/or pictures of the area(s) transmitted from the camera system 300.

In some implementations, monitoring the area(s) adjacent to the trailer 30 comprises using the application on the computing device to receive and view a live streaming of the video captured and transmitted from the camera system 300.

In some implementations, monitoring the area(s) adjacent to the trailer 30 further comprises saving and/or storing video and/or pictures captured by the camera system 300. In some implementations, the captured video and/or pictures are saved and/or stored to a removable media memory device 380 such as an SD (Secure Digital) memory card. In some implementations, the captured video and/or pictures are saved and/or stored for insurance, police, and/or safety review purposes (e.g., in case of an accident).

In some implementations, the captured video and/or pictures may be saved and/or stored to a cloud based storage memory. For example, in some implementations, the captured video and/or pictures may be saved and/or stored to a data storage of a remote server, such as described below for FIG. 1.

In some implementations, monitoring the area(s) adjacent to the trailer 30 comprises the camera system 300 providing an infrared camera function. In some implementations, the infrared camera function is automatically switched on and/or off by the camera system 300.

In some implementations, monitoring the area(s) adjacent to the trailer 30 further comprises the camera system 300 using the light source 360, such as to allow the camera system 300 to function in darkness or other low light conditions.

In some implementations, monitoring the area(s) adjacent to the trailer 30 further comprises the camera system 300 using the sensor 370 to detect objects or other obstacles in the back-up path of the trailer 30. In some implementations, the sensor 370 may provide a proximity sensing and/or distance measuring function to the camera system 300.

In some implementations, monitoring the area(s) adjacent to the trailer 30 further comprises the application providing a warning or alert from the computing device in response to the camera system 300 detecting an obstacle in the monitored area(s) adjacent to the trailer 30.

In some implementations, the method may further comprise removing the camera system 300 from the positioning on the trailer 30 after the use of the semitrailer collision avoidance system 100 is completed.

With respect to the multi-part 310a, 310b housing 310 described for FIG. 4C, in some implementations, removing the camera system 300 from the positioning on the trailer 30 comprises at least partly joining the parts 310a, 310b together. For example, as shown in FIG. 4B, in some implementations, the second part 310b is rotated/moved to at least partly join the parts 310a, 310b together while the first part 310a is attached/positioned on the trailer 30.

As described above, in some implementations, the second part 310b may rotated/moved remotely/automatically using the application, manually by a driver, or in any other suitable way.

FIG. 1 illustrates an implementation of an example environment of a semitrailer collision avoidance system 100 according to the present disclosure.

As shown in FIG. 1, in some implementations, the environment 100 may include a camera system 300, one or more client devices 110 (e.g., a smart phone/device 110a or a video monitor(ing) device 110b), a wireless cellular network 120, a network 125 (e.g., an Internet/VPN network 125a or a hotspot/Wi-Fi/captive-Wi-Fi network 125b), and one or more servers 130. In some implementations, the environment 100 may also include one or more data storage 130a linked to the server 130.

As discussed above, in some implementations, a computing device (“client device”) 110 may be used by users of the camera system 300 to remotely interface with the camera system 300 of the present disclosure discussed above. As discussed above, in some implementations, the client device 110 may be used to receive and display video and/or pictures captured by the camera system 300.

In some implementations, the client device 110 may be used to receive and display live stream video from the camera system 300. In some implementations, the client device 110 may be used to receive a detection indication from the camera system 300 of an obstacle in area(s) monitored by the camera system 300.

In some implementations, the client device 110 may be used to turn on and/or off one or more components of the camera system 300. In some implementations, the client device 110 may be used to start and/or stop one or more functions of the camera system 300.

In some implementations, the client device 110 may be used to program one or more functions of the camera system 300. In some implementations, the client device 110 may be used to remotely and/or automatically rotate/move the parts 310a, 310b of the housing 310 apart/together during use/operation of the camera system 300, such as describe above.

In some implementations, the client device 110 may be used to otherwise monitor and/or control the camera system 300.

In some implementations, the server 130 may be used to save and/or store video and/or pictures captured by the camera system 300. For example, in some implementations, the captured video and/or pictures may be saved and/or stored to the data storage 130a of the server 130.

The client device 110 is depicted as a mobile phone or a video monitor device, but the client device 110 may comprise any type of computing device, such as a desktop computer system, a laptop, cellular phone, a smart device, a mobile telephone, a tablet-style computer, or any other device capable of wireless or wired communication. In some implementations, client device 110 is configured to interact with the server 130 via an application, such as a web browser or a native application, residing on the client device 110.

In some implementations, the client devices 110 includes hardware, software, or embedded logic components or a combination of two or more such components and is configured to carry out the appropriate functions implemented or supported by the client devices 110.

In some implementations, the client devices 110 may include one or more processors, one or more memories, one or more displays, one or more interfaces, one or more components capable of inputting data, one or more components capable of outputting data, one or more components capable of communicating with any other component of the environment 100, of the camera system 300, or any other component suitable for a particular purpose.

In some implementations, the client devices 110 are configured to access networks 120 and/or 125. In some implementations, the client devices 110 are configured to communicate with servers 130.

In some implementations, the client device 110 can connect to the network 125 through a wireless cellular network 120, such as GPRS-based and CDMA-based wireless networks, as well as 802.16 WiMax and long-range wireless data networks.

In some implementations, components of the environment 100 may communicate with any other component of the environment 100 over network 125. Network 125 may be any suitable network. In some implementations, for example, one or more portions of network 125 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, another network 125, or a combination of two or more of the foregoing.

In some embodiments, components of the environment 100 may be configured to communicate over links 150. Links 150 may connect components of the environment 100 to networks 120, 125 or to each other. In some implementations, one or more links 150 may include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links 150 may each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link, or a combination of two or more such links 150. Links 150 may not be the same throughout the environment 100.

In some implementations, the server devices 130 may include a processor, memory, user accounts, and one or more modules to perform various functions such as those described above.

In some implementations, each server 130 may be a unitary server or may be a distributed server spanning multiple computers or multiple datacenters. Servers 130 may be of various types, such as, for example and without limitation, web server, file server, application server, exchange server, database server, or proxy server. In some implementations, each server 130 may include hardware, software, or embedded logic components or a combination of two or more such components for carrying out the appropriate functionalities implemented or supported by server 130. For example, a web server is generally capable of hosting websites containing web pages or particular elements of web pages. More specifically, a web server may host HTML files or other file types, or may dynamically create or constitute files upon a request, and communicate them to clients 110 in response to HTTP or other requests from clients 110. A database server is generally capable of providing an interface for managing data stored in one or more data stores.

In some implementations, one or more data storages 130a may be communicatively linked to one or more servers 130, respectively, via one or more links 150. In some implementations, data storages 130a may be used to store various types of information. In some implementations, the information stored in data storages 130a may be organized according to specific data structures. In particular embodiment, each data storage 130a may be a relational database. Particular embodiments may provide interfaces that enable servers 130 or clients 110 to manage, e.g., retrieve, modify, add, or delete, the information stored in data storage 130a.

FIG. 2 illustrates an example computer system 200, which may be used with some implementations of the present invention. This disclosure contemplates any suitable number of computer systems 200.

This disclosure contemplates computer system 200 taking any suitable physical form. In some implementations, as an example and not by way of limitation, computer system 200 may be an embedded computer system, a system-on-chip (SOC), a single-board computer system (SBC) (such as, for example, a computer-on-module (COM) or system-on-module (SOM)), a desktop computer system, a laptop, an interactive kiosk, a mainframe, a mesh of computer systems, a mobile telephone, a personal digital assistant (PDA), a server, or a combination of two or more of these.

In some implementations, where appropriate, computer system 200 may include one or more computer systems 200; be unitary or distributed; span multiple locations; span multiple machines; or reside in a cloud, which may include one or more cloud components in one or more networks.

In some implementations, where appropriate, one or more computer systems 200 may perform without substantial spatial or temporal limitation one or more steps of one or more methods described or illustrated herein. In some implementations, as an example and not by way of limitation, one or more computer systems 200 may perform in real time or in batch mode one or more steps of one or more methods described or illustrated herein. In some implementations, one or more computer systems 200 may perform at different times or at different locations one or more steps of one or more methods described or illustrated herein, where appropriate.

In some implementations, computer system 200 includes a processor 202, memory 204, storage 206, an input/output (I/O) interface 208, a communication interface 210, and a bus 212. Although this disclosure describes and illustrates a particular computer system having a particular number of particular components in a particular arrangement, this disclosure contemplates any suitable computer system having any suitable number of any suitable components in any suitable arrangement.

In some implementations, processor 202 includes hardware for executing instructions, such as those making up a computer program. In some implementations, as an example and not by way of limitation, to execute instructions, processor 202 may retrieve (or fetch) the instructions from an internal register, an internal cache, memory 204, or storage 206; decode and execute them; and then write one or more results to an internal register, an internal cache, memory 204, or storage 206.

In some implementations, processor 202 may include one or more internal caches for data, instructions, or addresses. The present disclosure contemplates processor 202 including any suitable number of any suitable internal caches, where appropriate. In some implementations, as an example and not by way of limitation, processor 202 may include one or more instruction caches, one or more data caches, and one or more translation look-aside buffers (TLBs).

In some implementations, instructions in the instruction caches may be copies of instructions in memory 204 or storage 206, and the instruction caches may speed up retrieval of those instructions by processor 202.

In some implementations, data in the data caches may be copies of data in memory 204 or storage 206 for instructions executing at processor 202 to operate on; the results of previous instructions executed at processor 202 for access by subsequent instructions executing at processor 202 or for writing to memory 204 or storage 206; or other suitable data.

In some implementations, the data caches may speed up read or write operations by processor 202. In some implementations, the TLBs may speed up virtual-address translation for processor 202.

In some implementations, processor 202 may include one or more internal registers for data, instructions, or addresses. The present disclosure contemplates processor 202 including any suitable number of any suitable internal registers, where appropriate. Where appropriate, processor 202 may include one or more arithmetic logic units (ALUs); be a multi-core processor; or include one or more processors 202. Although this disclosure describes and illustrates a particular processor, this disclosure contemplates any suitable processor.

In some implementations, memory 204 includes main memory for storing instructions for processor 202 to execute or data for processor 202 to operate on. In some implementations, as an example and not by way of limitation, computer system 200 may load instructions from storage 206 or another source (such as, for example, another computer system 200) to memory 204.

In some implementations, processor 202 may then load the instructions from memory 204 to an internal register or internal cache. In some implementations, to execute the instructions, processor 202 may retrieve the instructions from the internal register or internal cache and decode them.

In some implementations, during or after execution of the instructions, processor 202 may write one or more results (which may be intermediate or final results) to the internal register or internal cache. In some implementations, processor 202 may then write one or more of those results to memory 204.

In some implementations, processor 202 executes only instructions in one or more internal registers or internal caches or in memory 204 (as opposed to storage 206 or elsewhere) and operates only on data in one or more internal registers or internal caches or in memory 204 (as opposed to storage 206 or elsewhere).

In some implementations, one or more memory buses (which may each include an address bus and a data bus) may couple processor 202 to memory 204. In some implementations, bus 212 may include one or more memory buses, as described below.

In some implementations, one or more memory management units (MMUs) reside between processor 202 and memory 204 and facilitate accesses to memory 204 requested by processor 202.

In some implementations, memory 204 includes random access memory (RAM). In some implementations, this RAM may be volatile memory, where appropriate.

In some implementations, where appropriate, this RAM may be dynamic RAM (DRAM) or static RAM (SRAM). Moreover, in some implementations, where appropriate, this RAM may be single-ported or multi-ported RAM. The present disclosure contemplates any suitable RAM.

In some implementations, memory 204 may include one or more memories 204, where appropriate. Although this disclosure describes and illustrates particular memory, this disclosure contemplates any suitable memory.

In some implementations, storage 206 includes mass storage for data or instructions. In some implementations, as an example and not by way of limitation, storage 206 may include an HDD, a floppy disk drive, flash memory, an optical disc, a magneto-optical disc, magnetic tape, or a Universal Serial Bus (USB) drive or a combination of two or more of these.

In some implementations, storage 206 may include removable or non-removable (or fixed) media, where appropriate. In some implementations, storage 206 may be internal or external to computer system 200, where appropriate. In some implementations, storage 206 is non-volatile, solid-state memory.

In some implementations, storage 206 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 206 taking any suitable physical form.

In some implementations, storage 206 may include one or more storage control units facilitating communication between processor 202 and storage 206, where appropriate. In some implementations, where appropriate, storage 206 may include one or more storages 206. Although this disclosure describes and illustrates particular storage, this disclosure contemplates any suitable storage.

In some implementations, I/O interface 208 includes hardware, software, or both providing one or more interfaces for communication between computer system 200 and one or more I/O devices. In some implementations, computer system 200 may include one or more of these I/O devices, where appropriate.

In some implementations, one or more of these I/O devices may enable communication between a person and computer system 200. In some implementations, as an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these.

In some implementations, an I/O device may include one or more sensors. This disclosure contemplates any suitable I/O devices and any suitable I/O interfaces 208 for them.

In some implementations, where appropriate, I/O interface 208 may include one or more device or software drivers enabling processor 202 to drive one or more of these I/O devices. I/O interface 208 may include one or more I/O interfaces 208, where appropriate. Although this disclosure describes and illustrates a particular I/O interface, this disclosure contemplates any suitable I/O interface.

In some implementations, communication interface 210 includes hardware, software, or both providing one or more interfaces for communication (such as, for example, packet-based communication) between computer system 200 and one or more other computer systems 200 or one or more networks.

In some implementations, as an example and not by way of limitation, communication interface 210 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 210 for it.

In some implementations, as an example and not by way of limitation, computer system 200 may communicate with an ad hoc network, a personal area network (PAN), a local area network (LAN), a wide area network (WAN), a metropolitan area network (MAN), or one or more portions of the Internet or a combination of two or more of these.

In some implementations, one or more portions of one or more of these networks may be wired or wireless. In some implementations, as an example, computer system 200 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these.

In some implementations, computer system 200 may include any suitable communication interface 210 for any of these networks, where appropriate. In some implementations, communication interface 210 may include one or more communication interfaces 210, where appropriate. Although this disclosure describes and illustrates a particular communication interface, this disclosure contemplates any suitable communication interface.

In some implementations, bus 212 includes hardware, software, or both coupling components of computer system 200 to each other. In some implementations, as an example and not by way of limitation, bus 212 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCI-X) bus, a serial advanced technology attachment (SATA) bus, a Video Electronics Standards Association local (VLB) bus, or another suitable bus or a combination of two or more of these.

In some implementations, bus 212 may include one or more buses 212, where appropriate. Although this disclosure describes and illustrates a particular bus, this disclosure contemplates any suitable bus or interconnect.

Herein, reference to a computer-readable storage medium encompasses one or more non-transitory, tangible computer-readable storage media possessing structure. In some implementations, as an example and not by way of limitation, a computer-readable storage medium may include a semiconductor-based or other integrated circuit (IC) (such, as for example, a field-programmable gate array (FPGA) or an application-specific IC (ASIC)), a hard disk, an HDD, a hybrid hard drive (HHD), an optical disc, an optical disc drive (ODD), a magneto-optical disc, a magneto-optical drive, a floppy disk, a floppy disk drive (FDD), magnetic tape, a holographic storage medium, a solid-state drive (SSD), a RAM-drive, a SECURE DIGITAL card, a SECURE DIGITAL drive, or another suitable computer-readable storage medium or a combination of two or more of these, where appropriate.

Herein, reference to a computer-readable storage medium excludes any medium that is not eligible for patent protection under 35 U.S.C. § 101. Herein, reference to a computer-readable storage medium excludes transitory forms of signal transmission (such as a propagating electrical or electromagnetic signal per se) to the extent that they are not eligible for patent protection under 35 U.S.C. § 101.

This disclosure contemplates one or more computer-readable storage media implementing any suitable storage. In some implementations, a computer-readable storage medium implements one or more portions of processor 202 (such as, for example, one or more internal registers or caches), one or more portions of memory 204, one or more portions of storage 206, or a combination of these, where appropriate.

In some implementations, a computer-readable storage medium implements RAM or ROM. In some implementations, a computer-readable storage medium implements volatile or persistent memory.

In some implementations, one or more computer-readable storage media embody software. Herein, reference to software may encompass one or more applications, bytecode, one or more computer programs, one or more executables, one or more instructions, logic, machine code, one or more scripts, or source code, and vice versa, where appropriate.

In some implementations, software includes one or more application programming interfaces (APIs). This disclosure contemplates any suitable software written or otherwise expressed in any suitable programming language or combination of programming languages.

In some implementations, software is expressed as source code or object code. In some implementations, software is expressed in a higher-level programming language, such as, for example, C, Perl, or a suitable extension thereof. In some implementations, software is expressed in a lower-level programming language, such as assembly language (or machine code).

In some implementations, software is expressed in JAVA. In some implementations, software is expressed in Hyper Text Markup Language (HTML), Extensible Markup Language (XML), or other suitable markup language.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure. For example. it will apparent to one of ordinary skill in the art that the invention may be used with any electronic network service, even if it is not provided through a website.

Any computer-based system that provides networking functionality can be used in accordance with the present invention even if it relies, for example, on e-mail, instant messaging or other forms of peer-to-peer communications, and any other technique for communicating between users. The invention is thus not limited to any particular type of communication system, network, protocol, format or application.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a tangible computer readable storage medium or any type of media suitable for storing electronic instructions, and coupled to a computer system bus. Furthermore, any computing systems referred to in the specification may include a single processor or may be architectures employing multiple processor designs for increased computing capability.

While the foregoing processes and mechanisms can be implemented by a wide variety of physical systems and in a wide variety of network and computing environments, the server or computing systems described below provide example computing system architectures for didactic, rather than limiting, purposes.

The present invention has been explained with reference to specific embodiments. For example, while embodiments of the present invention have been described as operating in connection with a network system, the present invention can be used in connection with any communications facility that allows for communication of messages between users, such as an email hosting site. Other embodiments will be evident to those of ordinary skill in the art. It is therefore not intended that the present invention be limited, except as indicated by the appended claims.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

The present disclosure encompasses all changes, substitutions, variations, alterations, and modifications to the example embodiments herein that a person having ordinary skill in the art would comprehend.

The figures, including photographs and drawings, comprised herewith may represent one or more implementations of the semitrailer collision avoidance system.

Details shown in the figures, such as dimensions, descriptions, etc., are exemplary, and there may be implementations of other suitable details according to the present disclosure.

Reference throughout this specification to “an embodiment” or “implementation” or words of similar import means that a particular described feature, structure, or characteristic is comprised in at least one embodiment of the present invention. Thus, the phrase “in some implementations” or a phrase of similar import in various places throughout this specification does not necessarily refer to the same embodiment.

Many modifications and other embodiments of the inventions set forth herein will come to mind to one skilled in the art to which these inventions pertain having the benefit of the teachings presented in the foregoing descriptions and the associated drawings.

The described features, structures, or characteristics may be combined in any suitable manner in one or more embodiments. In the above description, numerous specific details are provided for a thorough understanding of embodiments of the invention. One skilled in the relevant art will recognize, however, that embodiments of the invention can be practiced without one or more of the specific details, or with other methods, components, materials, etc. In other instances, well-known structures, materials, or operations may not be shown or described in detail.

While operations may be depicted in the drawings in a particular order, this should not be understood as requiring that such operations be performed in the particular order shown or in sequential order, or that all illustrated operations be performed, to achieve desirable results.

1. A semitrailer collision avoidance system, comprising:
a camera system and a computing device, wherein the computing device is separate from the camera system and the camera system comprises a housing, an attachment mechanism, a camera, and a computer system, and wherein:
the housing comprises a first part, a second part, and a hinge, wherein:
the first part and the second part are movably connected together by the hinge such that the parts can be moved apart and moved together while the camera system is attached to a semitrailer of a tractor trailer vehicle;
the attachment mechanism is attached to the first part and is configured to removably attach the camera system to a semitrailer of a tractor trailer vehicle;
the camera is attached to the second part and is configured to capture images; and
the computer system is in the housing and configured to wirelessly interface the camera system to the computing device;
the camera system is configured to wirelessly transmit images captured by the camera to the computing device while the camera system is attached to a semitrailer of a tractor trailer vehicle; and
the computing device is configured to wirelessly interface with the camera system, wherein:
the computing device is configured to wirelessly receive images captured by the camera and wirelessly transmitted from the camera system while the computing device is positioned in the tractor of the tractor trailer vehicle; and
the computing device is configured to display images received from the camera system such that a driver can view the images while operating the tractor of the tractor trailer vehicle.

2. The semitrailer collision avoidance system of claim 1, wherein:
the camera system further comprises a mechanism configured to operate the hinge such that the second part is moved away from or moved toward the first part while the camera system is attached at the first part to a semitrailer of a tractor trailer vehicle; and
the computing device is further configured to wirelessly cause the mechanism to operate the hinge and adjust the position of the second part from the first part.

3. The semitrailer collision avoidance system of claim 1, wherein the computing device is further configured to wirelessly cause the camera system to capture and transmit images to the computing device.

4. The semitrailer collision avoidance system of claim 1, wherein the computing device is further configured to provide a wireless hotspot network that allows the computing device and the camera system to privately wirelessly connect.

5. The semitrailer collision avoidance system of claim 1, wherein:
the camera system further comprises a sensor, wherein the sensor is configured to allow the camera system to detect an object adjacent to the camera system;
the camera system is further configured to wirelessly transmit an alert to the computing device when an object is detected adjacent to the camera system; and
the computing device is further configured to receive and provide the alert from the camera system to a driver while operating the tractor of the tractor trailer vehicle.

6. The semitrailer collision avoidance system of claim 1, wherein:
the camera system further comprises a sensor, wherein the sensor is configured to allow the camera system to determine the distance between the camera system and an adjacent object;
the camera system is further configured to wirelessly transmit an alert to the computing device when an object is detected within a predetermined distance of the camera system; and
the computing device is further configured to receive and provide the alert from the camera system to a driver while operating the tractor of the tractor trailer vehicle.

7. The semitrailer collision avoidance system of claim 1, wherein:
the camera system further comprises a light source, wherein the light source is configured to provide light to allow the camera to capture images during a low light condition; and
the camera system is further configured to turn on the light source during a low light condition.

8. The semitrailer collision avoidance system of claim 1, wherein the camera system further comprises a memory device, wherein the memory device is configured to store images captured by the camera on a removable media.

9. The semitrailer collision avoidance system of claim 1, wherein the computing device comprises a video monitor device.

10. The semitrailer collision avoidance system of claim 1, wherein the computing device comprises a smart phone device.

11. A method of using the semitrailer collision avoidance system of claim 1, comprising:
attaching the camera system to a semitrailer of a tractor trailer vehicle at the first part by the attachment mechanism, wherein the camera system is attached to the semitrailer at a position that allows the camera to capture images from a desired area adjacent to the semitrailer;
separating the second part away from the first part by the hinge such that the camera is aimed toward the desired area adjacent to the semitrailer to allow the camera to capture images from the desired area;
activating the camera system to capture images by the camera and wirelessly transmit the images to the computing device by the computer system; and
viewing images received from the camera system and displayed by the computing device while operating the tractor of the tractor trailer vehicle such that a collision of the semitrailer with an object is avoided.

12. A method of using the semitrailer collision avoidance system of claim 2, comprising:
attaching the camera system to a semitrailer of a tractor trailer vehicle at the first part by the attachment mechanism, wherein the camera system is attached to the semitrailer at a position that allows the camera to capture images from a desired area adjacent to the semitrailer;
separating the second part away from the first part by the hinge such that the camera is aimed toward the desired area adjacent to the semitrailer to allow the camera to capture images from the desired area, wherein the second part is moved by wirelessly activating the mechanism by the computing device to operate the hinge;
activating the camera system to capture images by the camera and wirelessly transmit the images to the computing device by the computer system; and
viewing images received from the camera system and displayed by the computing device while operating the tractor of the tractor trailer vehicle such that a collision of the semitrailer with an object is avoided.

13. A method of using the semitrailer collision avoidance system of claim 3, comprising:
attaching the camera system to a semitrailer of a tractor trailer vehicle at the first part by the attachment mechanism, wherein the camera system is attached to the semitrailer at a position that allows the camera to capture images from a desired area adjacent to the semitrailer;
separating the second part away from the first part by the hinge such that the camera is aimed toward the desired area adjacent to the semitrailer to allow the camera to capture images from the desired area;
activating the camera system to capture images by the camera and wirelessly transmit the images to the computing device by the computer system, wherein the camera system is activated wirelessly by the computing device; and
viewing images received from the camera system and displayed by the computing device while operating the tractor of the tractor trailer vehicle such that a collision of the semitrailer with an object is avoided.

14. A computer-implemented method, comprising:
wirelessly receiving at a computing device positioned in a tractor of the tractor trailer vehicle images from a camera system attached to a semitrailer of the tractor trailer vehicle, wherein the computing device is separate from the camera system and the camera system comprises a housing, an attachment mechanism, a camera, and a computer system, and wherein:
the housing comprises a first part, a second part, and a hinge, wherein:
the first part and the second part are movably connected together by the hinge such that the parts can be moved apart and moved together while the camera system is attached to a semitrailer of a tractor trailer vehicle;
the attachment mechanism is attached to the first part and is configured to removably attach the camera system to a semitrailer of a tractor trailer vehicle;
the camera is attached to the second part and is configured to capture images; and
the computer system is in the housing and configured to wirelessly interface the camera system to the computing device;
the camera system is configured to wirelessly transmit images captured by the camera to the computing device while the camera system is attached to a semitrailer of a tractor trailer vehicle; and
the computing device is configured to wirelessly interface with the camera system, wherein:
the computing device is configured to wirelessly receive images captured by the camera and wirelessly transmitted from the camera system while the computing device is positioned in the tractor of the tractor trailer vehicle; and
the computing device is configured to display images received from the camera system such that a driver can view the images while operating the tractor of the tractor trailer vehicle.

15. The computer-implemented method of claim 14, wherein:
the camera system further comprises a mechanism configured to operate the hinge such that the second part is moved away from or moved toward the first part while the camera system is attached at the first part to a semitrailer of a tractor trailer vehicle; and
the method further comprises wirelessly activating the mechanism by the computing device causing the second part to move away from the first part such that the camera is aimed toward the desired area adjacent to the semitrailer to allow the camera to capture images from the desired area.

16. The computer-implemented method of claim 14, further comprising wirelessly activating the camera system by the computing device to capture images by the camera and wirelessly transmit the images to the computing device by the computer system.

17. The computer-implemented method of claim 14, wherein:
the camera system further comprises a sensor, wherein the sensor is configured to allow the camera system to detect an object adjacent to the camera system;
the camera system is further configured to wirelessly transmit an alert to the computing device when an object is detected adjacent to the camera system; and
the method further comprises receiving and providing the alert from the camera system by the computing device to a driver operating the tractor of the tractor trailer vehicle.

18. The computer-implemented method of claim 14, wherein:
the camera system further comprises a sensor, wherein the sensor is configured to allow the camera system to determine the distance between the camera system and an adjacent object;
the camera system is further configured to wirelessly transmit an alert to the computing device when an object is detected within a predetermined distance of the camera system; and
the method further comprises receiving and providing the alert from the camera system by the computing device to a driver operating the tractor of the tractor trailer vehicle.

19. A semitrailer collision avoidance system, comprising:
a camera system and a computing device, wherein the computing device is separate from the camera system and the camera system comprises a housing, an attachment mechanism, a camera, and a computer system, and wherein:
the housing comprises a first part, a second part, a hinge, and a mechanism, wherein:
the first part and the second part are movably connected together by the hinge such that the parts can be moved apart and moved together while the camera system is attached to a semitrailer of a tractor trailer vehicle;
the mechanism is configured to operate the hinge such that the second part is moved away from or moved toward the first part while the camera system is attached at the first part to a semitrailer of a tractor trailer vehicle;
the attachment mechanism is attached to the first part and is configured to removably attach the camera system to a semitrailer of a tractor trailer vehicle;
the camera is attached to the second part and is configured to capture images; and
the computer system is in the housing and configured to wirelessly interface the camera system to the computing device;
the camera system is configured to wirelessly transmit images captured by the camera to the computing device while the camera system is attached to a semitrailer of a tractor trailer vehicle; and
the computing device is configured to wirelessly interface with the camera system, wherein:
the computing device is configured to wirelessly receive images captured by the camera and wirelessly transmitted from the camera system while the computing device is positioned in the tractor of the tractor trailer vehicle;
the computing device is configured to display images received from the camera system such that a driver can view the images while operating the tractor of the tractor trailer vehicle;
the computing device is configured to wirelessly cause the mechanism to operate the hinge and adjust the position of the second part from the first part; and
the computing device is configured to wirelessly cause the camera system to capture and transmit images to the computing device.

20. The semitrailer collision avoidance system of claim 19, wherein:
the computing device is further configured to provide a wireless hotspot network that allows the computing device and the camera system to privately wirelessly connect;
the camera system further comprises a sensor, wherein the sensor is configured to allow the camera system to detect an object adjacent to the camera system;
the camera system is further configured to wirelessly transmit an alert to the computing device when an object is detected adjacent to the camera system;
the computing device is further configured to receive and provide the alert from the camera system to a driver while operating the tractor of the tractor trailer vehicle;
the camera system further comprises a light source, wherein the light source is configured to provide light to allow the camera to capture images during a low light condition;
the camera system is further configured to turn on the light source during a low light condition; and
the camera system further comprises a memory device, wherein the memory device is configured to store images captured by the camera on a removable media.
